(19) United States
(12) Patent Application Publication
(10) Pub. No.: US 2006/0194565 A1
(43) Pub. Date: Aug. 31, 2006

(54) Super block

(76) Inventors: David R. Smith, Camarillo, CA (US); Stephen J. Weinert, Arlington, TX (US); Michael L. Yeilding, Fremont, CA (US)

Correspondence Address: MATTHEW E. BURR;LAKE AUSTIN MARINA, 2219 WESTLAKE DR, STE 200, AUSTIN, TX, 78746, US

(21) Appl. No.: 11/068,521

(22) Filed: Feb. 28, 2005

(51) Int. Cl. H04B 1/08

(52) U.S. Cl. 455/347

(57) ABSTRACT

A communications terminal block that houses a substantially horizontal pin bed with at least one pin disposed at an angle of less than 90 degrees relative to the bed provides access and safety advantages. A kit that includes such a block together with adhesive labels, replacement fanning strips, mounting hardware and so forth provides convenience.

### FIELD OF THE INVENTION

The present invention relates to telecommunications equipment, and particularly to a connecting block terminal block assembly for termination of central office equipment and cross-connect facilities.

### BACKGROUND OF THE INVENTION

Presently, the blocks available for use in the telecomm industry are designed with the connecting pins facing out, directly toward a user standing in front of the block. This configuration sometimes makes counting the pins, connecting wire, and disconnecting wire difficult. Standard blocks present a problem when mounted on lower shelves and on upper shelves because the user must adopt a position where their face is directly in front of the block so the user can see the designations and count the pins.

### BRIEF DESCRIPTION OF THE DRAWINGS

The present invention is further described in the detailed description that follows, by reference to the noted drawings, by way of non-limiting examples of embodiments of the present invention, in which reference numerals represent the same parts throughout the several views of the drawings, and in which:

FIG. 1 is an isometric top view of a typical prior art telecom block.

FIG. 2 is an isometric view schematic drawing of an exemplary embodiment of a super block of the present invention.

FIG. 3 is a front view schematic drawing of the super block embodiment of FIG. 2.

FIG. 4 is rear view schematic drawing of the super block embodiment of FIG. 2.

FIG. 5 is a side view cross-section schematic drawing of the super block embodiment of FIG. 2.

FIG. 6 is a bottom view schematic drawing of the super block embodiment of FIG. 2.

### DETAILED DESCRIPTION OF THE INVENTION

In view of the foregoing, the present invention, through one or more of its various aspects, embodiments and/or specific features or sub-components, is thus intended to bring out one or more of the advantages that will be evident from the description. The present invention is described with frequent reference to communication terminal blocks. It is understood, however, that communication is merely an example of a specific embodiment of the present invention, which is directed broadly to electrical termination blocks within the scope of the invention. The terminology, examples, drawings and embodiments, therefore, are not intended to limit the scope of the invention.

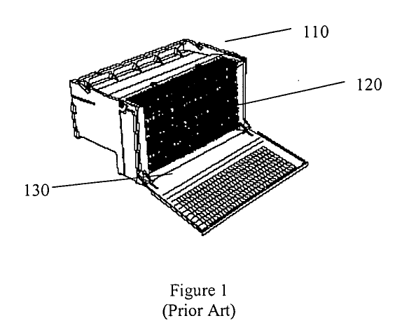

FIG. 1 is an isometric view of a typical prior art telecom block 110. As shown in FIG. 1, existing blocks used in the telecom industry have connecting pins 120 facing the front 130 of block 110.

The present invention solves many problems inherent in the prior art. For instance, with the Super Block of the present invention, the user can see the pins and count them with out having to position their eyes immediately in front of the block. The Super Block of the present invention is an improved design over prior art covered connecting blocks. While the overall dimensions are the same as the other available blocks, the Super Block differs significantly in its features and advantages.

The Super Block is designed so that the connecting pin bed is positioned approximately horizontally on the top of the block. The configuration makes access on low mounted blocks considerably easier and saves approximately four inches of wire on each wire connected.

Note that in the description of the present invention, connecting pins are described by referenced to wire/jumper/cable attachments. It will be understood by those skilled in the art, however, that pin connection may be accomplished by any number of selected means, including punch-down, screw-down, wire-wrap, quick-connect, and loop and latch.

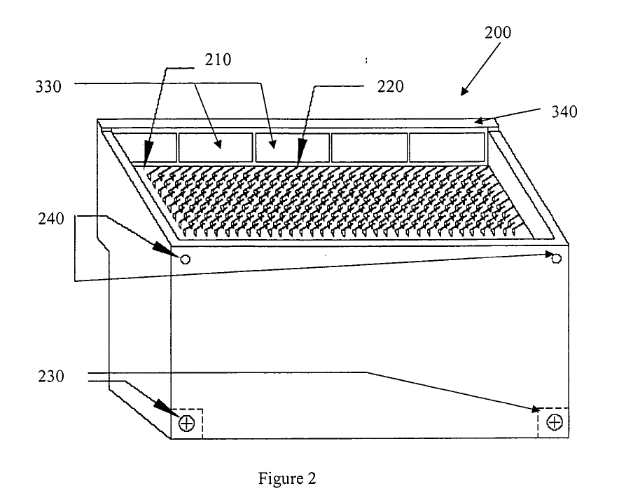

FIG. 2 is an isometric top view schematic drawing of an exemplary embodiment of a Super Block of the present invention. To facilitate ease of access, block 200 provides pin bed 210 on the top of the unit facing the individual when mounted horizontally, and angled forward fifteen degrees relative to the horizontal. Pin bed 210 tilts toward the user and allows for relatively easy access to, and more accurate counting of, the pins. A further advantage of tilted pin bed 210 on top of unit 200 is that wire clippings and other foreign material naturally migrate to the front and fall off block 200.

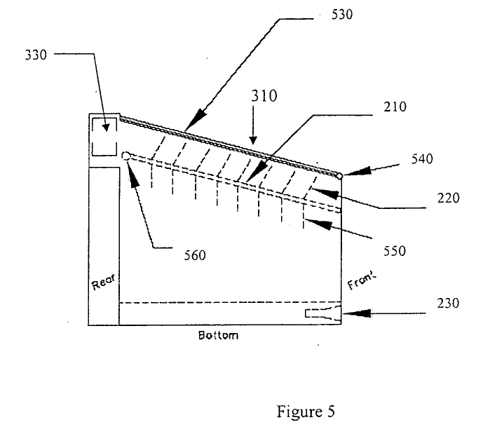

Pins 220 are preferably set into the pin bed at an angle of thirty degrees toward the front of block 200 to further enhance the ease of access to the pins for the user. Pin 200 designations are on the left side of pin bed 210 to provide a spacing of approximately 3/16″ between pins. Such a configuration provides additional working space for the wiring and the tools used to connect and remove the wires. Mounting holes 240 are provided for mounting a cover (see FIG. 5) on unit 200. Fasteners 230 lock pin bed 210 in place.

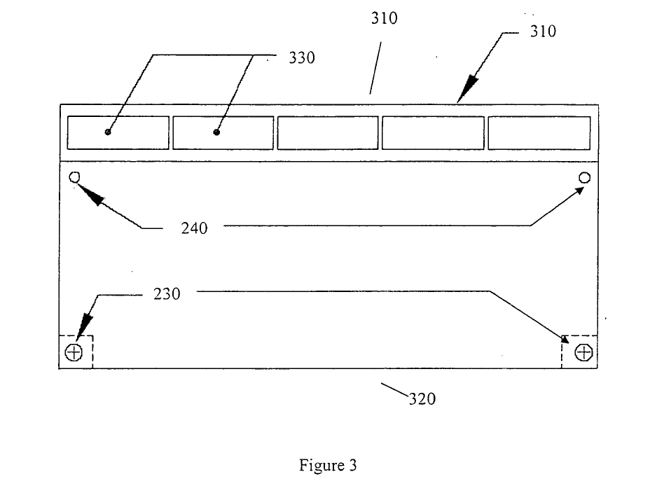

FIG. 3 is a front view schematic drawing of the super block embodiment of FIG. 2. Access holes 330 and jumper fanning strip 340 are positioned along top 310 of the unit. Fasteners 230 are near bottom 320 to secure unit 200 in place.

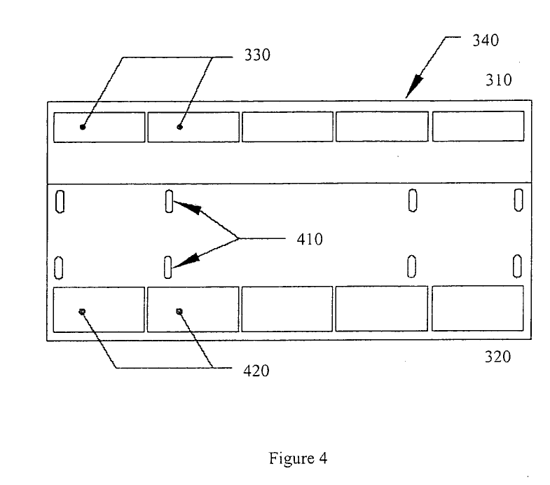

FIG. 4 is rear view schematic drawing of the super block embodiment of FIG. 2. Mounting slots 410 are distributed above cabling access holes 420.

FIG. 5 is a side view cross-section schematic drawing of the super block embodiment of FIG. 2. Block 200 cover 530 extends along top 310 from front 510 to rear 520 and pivots forward from pivot 540. Pin bed 210 tilts upward 15 degrees from the horizontal. Pin bed 210 pivots up and down from pivot 560. Connecting pins 220, for frame jumpers, angle forward 30 degrees from the horizontal. Connecting pins 550, for switch cable, suspend approximately parallel to front and rear of block 200. Fastener 230 is recessed in front 510 of unit 200. Access hole 330 is positioned toward the rear and top of unit 200.

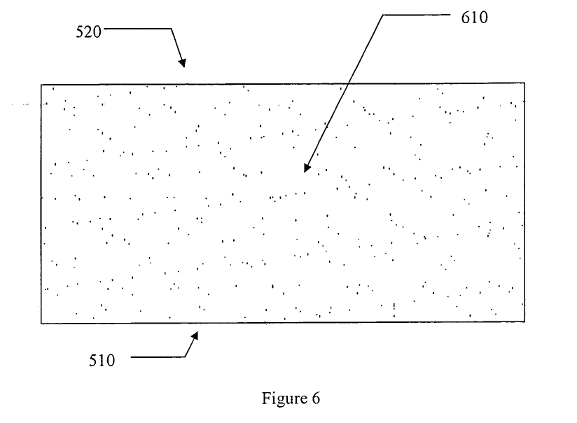

FIG. 6 is a bottom view schematic drawing of the super block embodiment of FIG. 2. Front 510 and rear 520 frame bottom 610 of block 200.

Multiple types of pins sets are contemplated including, of course, standard wire-wrap and punch-down sets, as well as single pin sets or bifurcated array embodiments. Termination types include Single Wire Wrap (SWW), Bifurcated Wire Wrap (BWW), and Bifurcated Quick Clip (BQC), among others.

Connector block 200 preferred dimensions are 7.94 inches wide, 4 inches high and 4.25 inches deep. Block 200 is sized to allow for mounting end to end on 8-inch centers. Mounting hole patterns measuring 3.75″×1.18″ (9.53 cm×3.03 cm) for standard frames and 7.5″×1.37″ (19.05 cm×3.48 cm) for older frames are preferred, with associated mounting hardware. The housing of block 200 preferably consists of non-conductive material that inhibits electrical connectivity of any kind across block 200.

Additional preferred specifications include:
Dielectric Strength—Minimum dielectric strength between any two conductors shall be 1000V RMS; and
Leakage Resistance—Leakage resistance between any two conductors shall exceed 1000 megohms at 100 VDC.

Specific embodiments provide a snap-on protective cover 530, capable of accepting appropriate stick-on labels to provide accurate circuit identification, together with labels provided with a block of the present invention.

Preferred embodiments further provide snap-through fanning strips sized to be capable of displaying two BOLD, hot stamped, alphanumeric characters that can be read by a person of normal eyesight from a minimum distance of 5 feet, for easy pin identification, block bodies, housings, and covers made of plastic, rather than metal, to minimize the chance of electric shock or personal injury.

Block 200 housings have sufficient points, at the rear of the block, to support switchboard/gray cable strain relief, as described in TP76300MP. Replaceable fanning strips may be provided. Fanning strips are available in several colors to facilitate the application block 200 is to be used for:
Yellow—Switch Terminations
White—Tie Cables
Blue—Outside Plant
Beige—Miscellaneous

Terminals located behind the plane of the fanning strips are recessed by at least approximately 1/16 of an inch.

Pins are recommended to be approximately equally spaced across the face of the block, regardless of the pin count. Pins or clips may be replaced without the need for special tools. The working length of the wire wrap pin is recommended to be no less than approximately 16/32 of an inch for both the front and back pins. The edges of the working length are approximately parallel, within 0.0045 inches per inch and preferably square, not rectangular. At least one shoulder is provided in specific embodiments to act as a stop for the wrapping tool.

Preferably, the working length is free of unusual nicks, burrs and other imperfections in the edges not common in the best punched parts workmanship. Burrs should not be more than 0.006 inch high.

The diagonal of the cross section of the flat punched terminals must be greater than 0.061 inch but preferably. The maximum diagonal shall not to exceed approximately 0.073 inch.

An approximately essentially straight working length, substantially free of angular bends or crimps, is recommended, although a small amount of bowing is permissible provided that the working length slides freely without binding into a tubular gauge with a maximum inside diameter of 0.074 inch and a length equal to the working length.

The cross-connect field may consist of several termination densities, up to 150 pairs. Accordingly, the pins are preferably set at a cumulative angle of forty-five degrees. The pin angle allows the user to make wire wrap connections at a comfortable angle for a more reliable connection.

Another advantage of Super Block 200 is provided by the single fanning strip embodiment. Standard blocks use at least a dual fanning strip configuration that requires wires to be routed through both fanning strips. Specific embodiments of block 200, in contrast, provide only one fanning strip required due to the pins being placed on top of the block. Such embodiments save approximately 4″ of wire for every wire terminated on the block.

The present invention offers increased versatility over existing blocks. It maximizes access and visibility from all horizontal levels. Vertical applications offer similar advantages along with increased protection for the pins as they are not facing outward. That is, by not facing outward, the pins tend to be protected from inadvertent contact with tools and test sets.

The block of the present invention provides improved accessibility, connections are easier to make, and the pins are better protected. Additionally, pin spacing remains consistent with the blocks in use today with 3/16^{th} of an inch between pins in specific embodiments. The cover on specific embodiments of block 200 provides an additional advantage in that it lays flat on top of the pins. Accordingly, the cover is less susceptible to falling open inadvertently or coming open from casual contact with wires as they are being installed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

We claim:

1. A communications terminal block housing a substantially horizontal pin bed comprising at least one pin disposed at an angle of less than 90 degrees relative to the bed.

2. A telecommunications connector block, the block comprising:
A housing comprising a top side; and
A pin bed disposed approximately horizontally on the top side of the housing.

3. The block of claim 2, wherein the pin bed is pivotally mounted to the housing.

4. The block of claim 2, wherein the housing further comprises a substantially horizontal bottom, a substantially vertical rear and a substantially vertical front side, wherein the pin bed is tilted less than ninety degrees toward the front of the block.

5. The block of claim 4, wherein the pin bed further comprises a plurality of connecting pins.

6. The block of claim 5, wherein at least one connecting pin is tilted toward the front of the block relative to the angle of the pin bed.

7. The block of claim 2, wherein the housing further comprises an electrically non-conductive substance.

8. The block of claim 2, further comprising a hinged cover to optionally cover the pin bed.

9. The block of claim 2, further comprising a snap-on cover pivotally mounted to the housing to optionally cover the pin bed.

10. The block of claim 2, wherein the pin bed further comprises at least two types of pins sets.

11. The block of claim 2, wherein the pin bed further comprises an array of pins and wherein the array is a single array.

12. The lock of claim 2, wherein the pin bed further comprises an array of pins and wherein the array is a bifurcated array.

13. The block of claim 2, further comprising replaceable fanning strips.

14. The block of claim 2, further comprising snap-through fanning strips.

15. The block of claim 2, further comprising a single fanning strip.

16. The block of claim 2, adapted for one or more selected application, wherein the application is selected from switch termination, tie cable, outside plant, and miscellaneous applications.

17. The block of claim 2, further comprising at least one wrapping tool stop.

18. The block of claim 2, wherein the pin bed further comprises a cross-connect field comprising a plurality of termination densities.

19. A kit comprising:
a telecommunications terminal block housing a substantially horizontal pin bed;
at least one stick-on label adhesive to the block;
at least one replacement fanning strip mountable on the block; and
mounting hardware to mount the block to a block support.

20. The kit of claim 19, wherein the pin bed comprises at least one pin disposed at an angle of less than 90 degrees relative to the bed.
